(19) United States
(12) Patent Application Publication
(10) Pub. No.: US 2003/0187614 A1
(43) Pub. Date: Oct. 2, 2003

(54) Method for adjustment of information

(76) Inventors: Erik Wallin, Stockholm (SE); Henrik Dyberg, Stockholm (SE)

Correspondence Address: FASTH LAW OFFICES, 629 E. BOCA RATON ROAD, PHOENIX, AZ, 85022, US

(21) Appl. No.: 10/395,905

(22) Filed: Mar. 24, 2003

(30) Foreign Application Priority Data
Mar. 28, 2002 (SE) 0200991-8

(51) Int. Cl. G06F 11/30

(52) U.S. Cl. 702/179

(57) ABSTRACT

The present invention relates to a method for adjusting information based on known information about a user. The adjustment is performed in several steps. Before the method is used an object of the system is provided with characteristics. The known information about a user is based on the objects the user has previously interacted with. The first step of the method is that the models (M1, M2, M3) are built up based on the characteristics of the object of the system. A first analysis (I) is carried out for these models together with the known information (II) about the user that provide a result of measuring values (I1, I2, I3) that reflect the relative strength of the model. A second analysis (III) is carried out as a second step of the measuring values the first analysis (I) developed to determine if any of the analyzed models (M1′, M2′, M3′) is significant to the user and if so which model is the most significant. As a last step of the method, the most significant model (M1″) is used in combination with the known information (5) about the user to build up a data structure (V) that in turn is used to adjust (VI) new information (6) to the new current user.

### TECHNICAL FIELD

The present invention relates to a method for adjusting information based on known information about a user.

### PRIOR ART

Today's society is characterized by the enormous amount of information that, voluntarily or not, is presented to users such as persons or machines. Particularly within the digital information channels, the information flow has increased tremendously.

To make communication between the provider and different users more effective, the information that is to be communicated should be adjusted according to the user the information is intended for. Otherwise the risk is great that the user may miss interesting information when it is drowned in the amount of information. This may mean for the provider of the information that the users are less satisfied due to missed intentions and lost profits as a result.

If a system can adjust the information to be presented in some way so that it is the most relevant and interesting information that is emphasized over other information, the likelihood that the user finds right information increases and an increased value is created both for the user and the provider of the information.

There are many pure systems for adjusting information according to a user's preferences. The patent publications WO 98/02835, WO 99/16003, U.S. Pat. No. 5,862,325 and U.S. Pat. No. 5,956,693 describe variations of such systems. These systems lack the possibility of automatically adjusting the information by dividing the users into groups. Instead, the systems require either the system administrator or the user to manually provide the system with sufficient information to enable the adjustment.

Other systems that use different analysis method are described in the patent publications WO 00/70481, U.S. Pat. No. 1,044,791, U.S. Pat. No. 5,704,017, U.S. Pat. No. 6,128,587, and EP 1 158 436. These publications described analysis and methods that are similar to the analysis and methods according to the present invention. It is to be understood that they are performed in completely different fields of use compared to the present invention.

Technical Problem

In view of the prior art, as described above, it is a problem in today's information intense society to provide the right user with the right information at the right time. When the information flow is almost indefinite the utility would in many cases increase if the user at an early stage and automatically is presented with suitable information. This problem may be resolved with a system, where an individually adapted selection of information, that is based on the user's earlier behavior, is presented automatically and in real time.

A technical problem of the current applications for individual adjustments is that they are done in “one dimension” with regard to the characteristics of the objects that are to be adapted. The object may, for example, be news articles and movie tickets. This means that when the characteristics of the objects are good for a specific user it is taken in account if these characteristics are better or worse when they act together or separately.

For example, a movie reservation system may attribute each film with two characteristics, film category and time. For simplicity, there are only two film categories, action and children and two show times, 5 pm and 9 pm. Assume a user has seen ten action films at 9 pm and ten children's films at 5 pm.

Further, there are four current films that are shown at the movie theater:

Action film at 5 pm

Action film at 9 pm

Children's film at 5 pm

Children's file at 9 pm

Of these four films the best film for the user is to be determined. This is to, for example, give the user a focused advertisement. With the individually adjusted algorithms that are available today it is not possible to distinguish these four films based on the user's history. In other words, the characteristics of the films the user has seen before. Because, according to the prior art, only “one dimension” is used, one only knows that the user has seen ten action films, ten children's films, ten films at 5 pm and ten films at 9 pm. All the characteristics thus have the same value. But the user has only seen action films at 9 pm and children's films at 5 pm so that two of the four films shown are completely uninteresting to the user based on the user's earlier behavior.

This deficiency is because no information about the dependencies and relationships of the information is saved in the system. In the described user's situation it is clear that there is a dependency relationship between children's films at 5 pm and action films at 9 pm. This relationship should be identified by a method and then be used for individualizing e.g. films, in a stronger way and more exactly compared to the earlier known methods. This is only an example of an application of the method. Other examples of applications could be adjustment of information in bank systems, Internet editions of newspapers, e-trade places etc.

It is a technical problem to automatically and in real time create a dependency between characteristics of information that is known of the user. The number of combinations of dependencies of information grows exponentially with increased number of characteristics. The method must be able to find dependencies directly without having to investigate all the possible dependencies. It is further a technical problem to be able to use the identified dependencies between the characteristics to more effectively adjust new information to a user.

Solution

The present invention intends to provide a solution to the above-outlined problem and is described in steps below. The solution may be said to have two steps where the first step includes finding possible dependencies between the characteristics based on known information about a user. The second step takes advantage of the identified dependencies of the known information to adjust new information to a current user. The steps of the solution are presented with items where items 1-5 correspond to the first step while 6-8 correspond to the second.

1. With the assistance of models in the form of, for example Bayesian networks, different characteristics of objects are represented and how these characteristics are related to one another whether they are dependent or not (FIG. 1). If there, for example, for a certain object, for a specific user, is a certain characteristic that is more frequent together with another characteristic, there exists a dependency between those characteristics.

2. By using the models that are described in item 1 and develop a probability distribution of, for example, the Dirichlet distribution type and apply known information about the user to this distribution a measurement value may be obtained that represent the relative strength of the model. With known information about a user it is here, for example, meant articles that the users have earlier looked at. The characteristics of the articles are already identified and stored in the system.

3. By using a pair of models (item 1) and putting in the calculated measurement value, that have been obtained according to item 2, in a comparison formula, for example the formula for Bayes factor, a relationship number is obtained for the pair analyzed. This relationship number tells which model in the pair that best represents the known information about the user if one model of the pair is better than the other.

4. After having compared all the combinations of the model, in the way described in item 3, a model that best represent the known information about the user can be identified. If it is shown that no model is sufficiently good to represent the known information, this fact is shown instead to symbolize that no model is significant for this user.

5. Based on the model that best represent the known information about the user i.e. the model that is the most significant, the dependencies represented by the model are identified.

6. With the help of the discovered dependency relationships a multi-dimensional data structure is created that includes all the combinations of the characteristics that are included in the dependency relationship for the user identified in item 5.

7. Every combination of the characteristics in the multi-dimensional data structure (item 6) is given a weight that represents how strong the combination of the characteristics is for the specific user. This weight is based on the known information about the specific user.

8. By using the built up multi-dimensional data structure for the specific user, an object with given characteristics can be sorted according how suitable its combination of characteristics is, as represented by a weight in the multi-dimensional data structure, for the user. In this way, a plurality of object can be sorted according to how well they suit the specific user.

Advantages

The big advantage of the method of the present invention is that is makes it possible to carry out substantially better and more targeted information adjustments compared to earlier methods. This is because the dependencies of the characteristics of a stored behavior of a user can be identified and used for the information adjustment.

The method is dynamic and scalable and the number of dimensions that can be handled when information is adjusted, i.e. between how many dependency characteristics can be identified, is unlimited.

The method makes it possible to use the method in a system that works in real time, i.e. the interactions from a user can directly be mirrored in the adapted information that is presented to the user.

The method can be used independently of the technical platform and can handle the mixing of different media and platforms.

### BRIEF DESCRIPTION OF DRAWINGS

The present invention is exemplified and described with reference to the appended drawings, where:

FIG. 1 schematically and very simplified shows three models for representation of the characteristics A, B, and C's relationship to one another,

FIG. 2 schematically shows how different components of the method act together and how the method progresses, and

FIG. 3 schematically shows a computer program product and a computer readable medium according to the present invention.

### DETAILED DESCRIPTION OF PREFERRED EMBODIMENTS

The present invention refers to a method for adjusting information based on known information about a user. Before the method is used, an object in the system must be given characteristics and that the characteristics of the objects that a user interacts with are saved and constitute the known information about a user.

Model Construction

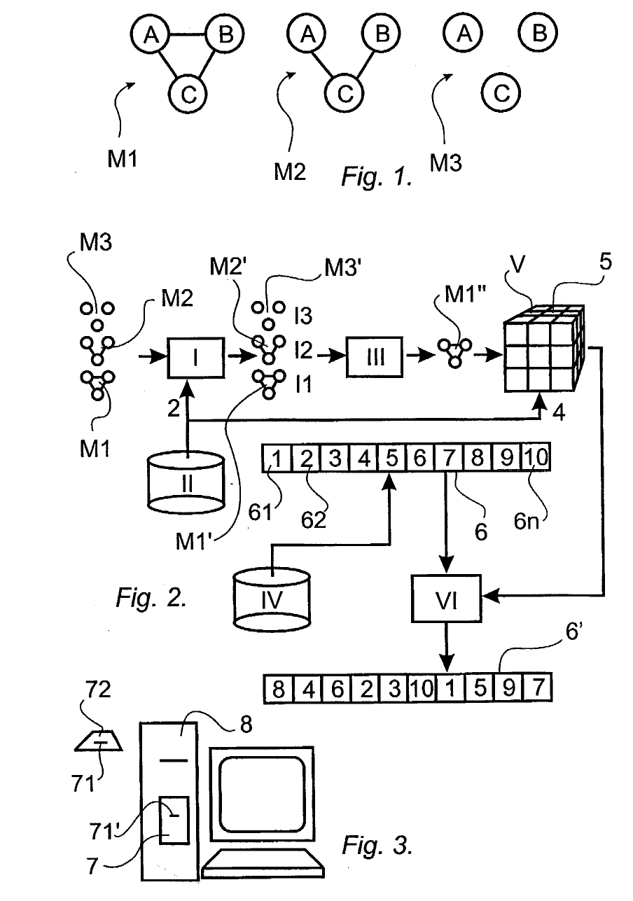

The method starts by constructing the models M1, M2, M3, as schematically shown in FIG. 1, that are based on the characteristics 2 of the system and the objects with which the user interacts. In the example of FIG. 1, the three different characteristics and their mutual dependencies are handled. These characteristics could, for example, be A: film category, such as action, romantic and children, B: time, such as 5 pm and 9 pm, and C: place, such as different movie theaters. With these models one can illustrate if there are dependencies between how the user selects his films relative these characteristics.

If a model is created that represents that three characteristics A, B and C are mutually dependent of one another, the model may, for example, look like M1 in FIG. 1. The model M1 represents the situation when a dependency exists between the characteristics A, B and C.

The model M2 shows how C is dependent upon A and B but A and B are independent of each other. In the example above, this would mean that there is a dependency between the place, characteristic C, and film category, characteristic A. There is also a dependency between the place, characteristic C, and time, characteristic B. However, there is no dependency between the film category, characteristic A and time, characteristic B.

In the model M3, A, B and C are independent of one another.

It is apparent that also other dependencies than the ones shown in FIG. 1 are possible and that these are only used to exemplify the dependencies according to M1, M2 and M3.

The models may be realized graphically or with visual representation such as Bayesian nets, Causal nets or ordinary graphics with directed and undirected edges, compare FIG. 1.

Analysis for Developing Measuring Values

FIG. 2 intends to illustrate how a first analysis 1, based on Dirichlet distribution, can be made on an object with characteristics according to the models M1, M2, M3 together with known information 2 about the user.

The first analysis intends to develop a measuring number I1, I2, I3 for each analyzed object. This measuring value is relative and does not say anything about the models M1′, M2′ and M3′. In relationship to the measuring values of the other models it is possible to determine which model M1′, M2′, M3′ that best represent the known information 2 about the user.

The known information 2 about a user is obtained from an information source called II. The known information can also be stored intermittently in the system such as known information about the user that the method is often used for. To intermittently store the known information has the advantage of improving the complexity of the method with regards to time since it is not necessary to obtain the same information many times from an external source such as a database.

Analysis for Comparing Measuring Values

The second analysis III is used to compare the different models M1′, M2′, M3′ with each other by applying the calculated measuring value I1, I2, I3 of each model to, for example, the Bayes factor 3. By performing the second analysis III on all the combinations of the measuring values of the models it can be determined if any of the models is significantly based on the known information 2 about the user. If it is shown that any of the models is significant the second analysis will also identify this model M1″.

Construction of Data Structure and Adjustment of Information

Based on the developed model M1″ and the known information 4 about the user a multi-dimensional data structure V is built up. The data structure may, for example, include arrays or vectors 5. This structure includes a place for each possible combination of the characteristics that may, based on the model M1″, exist. Weighted frequency values are placed in this structure for the different combinations of characteristics based on how frequent the combinations have been in the known information 5 about the user.

This data structure 5, filled with this information, is then used to adapt VI new information 6 to the user. The new information 6 can be classified regarding how well it is assumed to be for the user based on the value of the combination of characteristics of the information in the data structure 5. The new information 6 comes in as a list where each position in the list corresponds to one of the objects 61, 62, . . . 6n.

To adjust this new information 6, the characteristics of the objects 61, 62 . . . 6n must be developed. These characteristics are obtained from a source IV. To adjust the objects in the list, the corresponding frequency values are obtained from the data structure V. The correct position in the data structure is found with the help of the combination characteristics of the objects. The objects in the list are sorted or adapted based on their frequency values. After the sorting/adjustment VI the object that best fits the user will appear first in the list 6′ since the corresponding frequency values in the data structure are the highest.

Characteristics of the Data Structure

The number of dimensions that are created based on the model that is believed to be the most significant for the current user are set completely dynamically. The number of dimensions can thus vary from one method iteration to another even if the same information about a user is analyzed. It is not necessary for the models that are built up and analyzed to have the identical number of characteristics as the object on which the analysis is based. The number can be limited and, for example, be part of the characteristics.

Direct/Delayed Re-Connection and Persistency

The described method for adjustment can be used so that the behavior of the user is directly reflected and has an impact on the new information that is to be adjusted. Another variant is to let the behavior of the user to come into play the next time the user returns to the system.

Further, the model can, as after the second analysis determines it to be most significant for the current user, be made permanent a longer time or only temporarily.

Suitability of the Method

The adjustment that the method carries out is suitable for both analysis of the individual user, clusters of user, complete populations of users and grouping of non-person things such as servers.

The characteristics that the object of the system have been given can be set with external and internal influences. With internal influences means the influences from the same system that the method operates within. With external means, for example, the influences from an independent system that is separate from the system the method operates within.

Miscellaneous

With reference to FIG. 3 it schematically shows that the present invention also relates to a computer program product 7, that includes the computer program code 71 that, when executed by a computer 8, is adjusted to carry out the method of the present invention to adjust new information to a user as described.

The present invention also relates to a computer readable medium 72, exemplified in the figure as a diskette, where the computer program code 71′ is stored according to the computer program product 7 of the present invention.

The present invention is of course not limited to the above examples of embodiments and may be modified without departing from the scope of the following claims.

1. A method for adjusting information based on known information about a user, characterized therein that an object is given characteristics, that the known information is based on the object the user has interacted with, that the models are built up for respective object based on the characteristics, that a first analysis is carried out together with the models so that a measuring value is created that reflects the relative strength of the models, that a second analysis is performed of the measuring value to determine whether the known information is sufficient for any of the models to be significant to the user and which of the models is the most significant, that the most significant model, in combination with the known information, are used to build up a data structure and that the data structure is used to adjust the information to the user.

2. The method according to patent claim 1 characterized therein that the first analysis is an analysis of a distribution, such as a Dirichlet distribution or a Bernoulli distribution.

3. The method according to patent claims 1 or 2 characterized therein that the second analysis is a comparison analysis, such as a function for calculating a Bayes factor by using different methods for interpreting the Bayes factor.

4. The method according to patent claim 4 characterized therein that the models are build up by relationships between the characteristics and are realized with a graphic or visual representation, such as Bayesian net, Causal net or ordinary graphics with directed and undirected edges.

5. The method according to any of the previous claims characterized therein that the data structure is a multidimensional dynamic array/vector type.

6. The method according to patent claim 5 characterized therein that the number of dimensions in the data structure is dynamically set from a first analysis to another first analysis.

7. The method according to patent claim 6 characterized therein that the number of dimensions of the data structure is based on the number of characteristics of the objects that are to be included in the first analysis and that different object can have different characteristics so that the number of dimensions of the data structures can vary from a first analysis to another first analysis.

8. The method according to patent claim 7 characterized therein that the adjustment can be used for a direct reconnection to the user.

9. The method according to patent claim 7 characterized therein that the adjustment can be used with delayed reconnection to the user.

10. The method according to patent claims 8 or 9 characterized therein that the user information is intermittently stored to improve for example the complexity with regards to time.

11. The method according to patent claim 10 characterized therein that the distribution is adjusted to the different models on which the distribution in applied.

12. The method according to patent claim 11 characterized therein that the models included in the first analysis are not limited to represent the number of characteristic that the object has but is limited in another way such as by being part of the characteristics.

13. The method according to any of the previous patent claims characterized therein that the most significant model is temporarily given to the user.

14. The method according to any of the patent claims 1-12 characterized therein that the most significant model is given to the user for a longer time or permanently.

15. The method according to any of the previous patent claims characterized therein that the adjustment is both suitable for analysis of individual users, clusters of users, complete populations of users and grouping of non-person things such as servers.

16. The method according to any of the previous patent claims characterized therein that the objects have been given the characteristics by an internal or external influence.

17. A computer program product characterized therein that the computer program product includes a computer program code which, when executed by a computer, makes the computer perform the method according to any of the previous claims.

18. A computer readable medium characterized therein that the computer readable medium is a computer program code stored according to claim 17.
